(19) United States
(12) Patent Application Publication
(10) Pub. No.: US 2008/0201959 A1
(43) Pub. Date: Aug. 28, 2008

(54) Eating utensil

(76) Inventor: Barry Leonard Kent, Lady Lake, FL (US)

Correspondence Address: BARRY KENT, 207 HANGING MOSS LANE, LADY LAKE, FL, 32159, US

(21) Appl. No.: 11/711,702

(22) Filed: Feb. 28, 2007

(51) Int. Cl. A47J 43/28

(52) U.S. Cl. 30/147

(57) ABSTRACT

A one piece eating utensil that will perform the tasks of a knife, fork and spoon. The invention is designed in one piece with no moving parts. The invention has a wide upper section that consists of two blunted knife edges that end at the top of the utensil in a three pronged fork. The center of the upper portion has a hollowed out center section that is the spoon area. Immediately below the upper section, on both side of the utensil, there are two flattened areas which allow the user to apply finger pressure on the side of the utensil when cutting food. The invention is ambidextrous.

### RELATED APPLICATIONS

The present application is a continuation-in-part application of United States provisional patent application, Ser. No. 60/777378, filed Feb. 27, 2006, for ONE PIECE, MULTI-PURPOSE, KNIFE, FORK & SPOON EATING UTENSIL, by Barr Kent, included by reference herein and for which benefit of the priority date is hereby claimed.

### FIELD OF THE INVENTION

The present invention relates to eating utensils and, more particularly, to an eating utensil that functions as a one-piece knife, fork and spoon.

### BACKGROUND OF THE INVENTION

It is common practice in the United States to eat a meal with only a fork. Eating with only a fork, however, has it drawback and problems. The edge of the fork is often used as a poor attempt at cutting food. If liquids such as sauces or gravy are on the plate, the person eating must exchange the fork for a spoon in order to cosume the liquids.

These drawbacks are more than eating inconveniences and truly a problem to people who are handicapped, suffering from diseases such as Parkinsons, the elderly, and those in the hospital. People in these categories have difficulty when trying to eat a meal with three different eating utensils.

Then there are others to whom coping with three different eating utensils is burdomsome. These include campers, people working in the field, and our military. These people need to travel as light as possible, however, they have to pack knives, forks, and spoons in their kits for eating purposes.

The objective of the invention is to enable varied people groups to eat a meal of various consistencies with only one eating utensil.

The only other eating utensil that even remotely solves only a part of these problems in eating food is a product called the spork. The spork tries to substitute for a combination spoon and fork. It is generally flimsy in construction and is used primarily in the fast food arena. A great drawback to the spork is that it cannot function as a knife.

It is therefore an object of the invention to eat a plate of food of various cosistencies with one eating utensil.

### SUMMARY OF THE INVENTION

In accordance with the present invention, there is provided a one piece eating utensil that will perform the tasks of a knife, fork and spoon.

The invention is constructed in one piece and has a wide upper section that consists of two blunted knife edges that end at the top of the utensil in a three pronged fork. The center of the upper portion has a hollowed out center section that is the spoon area. Immediately below the upper section, on both side of the utensil, there are two flattened areas which allow the user to apply finger pressure on the side of the utensil when cutting food.

The utensil can be made from various materials such as precious metal, metal, wood, compressed wood, plastic, polypropylene, poly vinyl acrylic.

The invention is ambidextrous.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of an one piece, multi-purpose eating utensil; and

FIG. 2 is a side view view of an one piece, multi-purpose eating utensil.

For purposes of clarity and brevity, like elements and components will bear the same designations and numbering throughout the Figures.

### DESCRIPTION OF THE PREFERRED EMBODIMENT

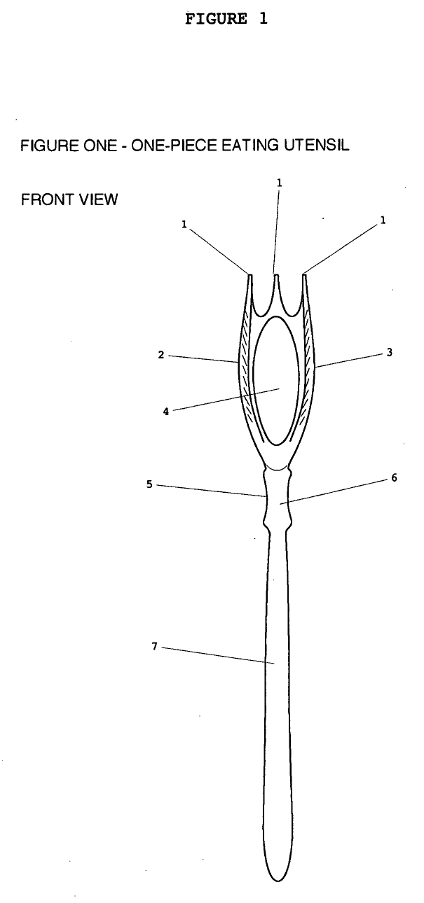

FIG. 1 is a front view of a one piece, multi-purpose eating utensil.

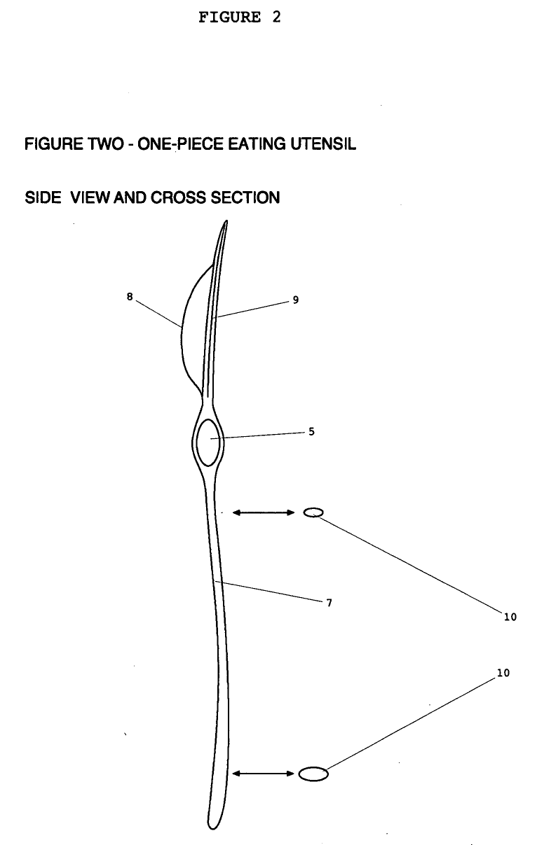

FIG. 2 is a side view of a one piece, multi-purpose eating utensil.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An eating utensil for eating food with a one piece, knife, fork and spoon, comprising:
means for spearing food;
means for cutting food with the right hand;
means for cutting food with the left hand;
means for spooning liquids;
means for applying pressure with the left hand, index finger to cut food;
means for applying pressure with the right hand index finger to cut food;
means for holding the utensil;
means for spooning liquids;
means for cutting food; and
means for holding the utensil.

2. The eating utensil in accordance with claim 1, wherein said means for spearing food comprises a fork section.

3. The eating utensil in accordance with claim 1, wherein said means for cutting food with the right hand comprises a blunt knife edge 1.

4. The eating utensil in accordance with claim 1, wherein said means for cutting food with the left hand comprises a blunt knife edge 2.

5. The eating utensil in accordance with claim 1, wherein said means for spooning liquids comprises a spoon area.

6. The eating utensil in accordance with claim 1, wherein said means for applying pressure with the left hand, index finger to cut food comprises an area for left hand, index finger.

7. The eating utensil in accordance with claim 1, wherein said means for applying pressure with the right hand index finger to cut food comprises an area for right hand, index finger.

8. The eating utensil in accordance with claim 1, wherein said means for holding the utensil comprises a handle.

9. The eating utensil in accordance with claim 1, wherein said means for spooning liquids comprises a bowl spoon area.

10. The eating utensil in accordance with claim 1, wherein said means for cutting food comprises a blunted knife edge.

11. The eating utensil in accordance with claim 1, wherein said means for holding the utensil comprises a cross sections of handle.

12. An eating utensil for eating food with a one piece, knife, fork and spoon, comprising:
a fork section, for spearing food;
a blunt knife edge 1, for cutting food with the right hand;
a blunt knife edge 2, for cutting food with the left hand;
a spoon area, for spooning liquids;
an area for left hand, index finger, for applying pressure with the left hand, index finger to cut food;
an area for right hand, index finger, for applying pressure with the right hand index finger to cut food;
a handle, for holding the utensil;
a bowl spoon area, for spooning liquids;
a blunted knife edge, for cutting food; and
a cross sections of handle, for holding the utensil.

13. An eating utensil for eating food with a one piece, knife, fork and spoon, comprising:
a fork section, for spearing food;
a blunt knife edge 1, for cutting food with the right hand;
a blunt knife edge 2, for cutting food with the left hand;
a spoon area, for spooning liquids;
an area for left hand, index finger, for applying pressure with the left hand, index finger to cut food;
an area for right hand, index finger, for applying pressure with the right hand index finger to cut food;
a handle, for holding the utensil;
a bowl spoon area, for spooning liquids;
a blunted knife edge, for cutting food; and
a cross sections of handle, for holding the utensil.
